(19) United States
(12) Patent Application Publication
(10) Pub. No.: US 2011/0032451 A1
(43) Pub. Date: Feb. 10, 2011

(54) LIQUID CRYSTAL DISPLAY DEVICE

(75) Inventors: Michihide SHIBATA, Mutsuzawa (JP); Hidehiro Hanada, Ichihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Display, Ltd.

(21) Appl. No.: 12/853,412

(22) Filed: Aug. 10, 2010

(30) Foreign Application Priority Data
Aug. 10, 2009 (JP) 2009-186078

(51) Int. Cl. G02F 1/1335

(52) U.S. Cl. 349/62

(57) ABSTRACT

A liquid crystal display device which can effectively suppress the occurrence of brightness irregularities without using additional members or complicated formed parts in miniaturizing the liquid crystal display device is provided. The liquid crystal display device includes: a liquid crystal display panel; and a backlight which illuminates the liquid crystal display panel, wherein the backlight includes a light guide plate, a plurality of light emitting diodes which are arranged on a side portion of the light guide plate, and an optical sheet member (a diffusion sheet, a prism sheet) which is arranged between the light guide plate and the liquid crystal display panel and has a light diffusion property or a light condensing property, and a cutaway portion is formed on a side of the optical sheet member in the vicinity of the light emitting diodes.

### CROSS-REFERENCE TO RELATED APPLICATION

This present application claims priority from Japanese application JP 2009-186078 filed on Aug. 10, 2009, the content of which is hereby incorporated by reference into this application.

### BACKGROUND OF THE INVENTION

1. Field of the Invention

The present invention relates to a liquid crystal display device, and more particularly to a liquid crystal display device where a backlight which illuminates a liquid crystal display panel includes an optical sheet.

2. Description of the Related Art

In many miniaturized electronic devices such as mobile phones or personal digital assistants, a liquid crystal display device has been used as a display device. Further, a demand for the reduction of thickness and the miniaturization of such a liquid crystal display device has been steadily increasing year by year.

As shown in FIG. 1, the liquid crystal display device is constituted of a liquid crystal display panel LCP in which color filters and electrodes which respectively correspond to pixels are arranged on surfaces of two transparent plate-shaped bodies such as a glass plate and, at the same time, a liquid crystal layer is arranged between the two plate-shaped bodies, and a backlight which illuminates the liquid crystal display panel. FIG. 1 is a cross-sectional view showing an arrangement state of main parts in the vicinity of an edge portion of the liquid crystal display device.

In the backlight, from a viewpoint of the reduction of thickness, a plurality of light emitting diodes LED are arranged on a side portion of a light guide plate LG in a spaced-apart manner from each other. Light emitted from the light emitting diodes is incident on the light guide plate from a side portion of the light guide plate, is propagated in the inside of the light guide plate, and is radiated from one surface of the light guide plate on a side where a liquid crystal display panel is arranged. To make light radiated from the light guide plate uniform within a display region of the liquid crystal display panel, as disclosed in JP-A-2002-202504, between the light guide plate and the liquid crystal display panel, an optical sheet member which is formed by stacking a plurality of optical sheets (for example, a diffusion sheet DS, a prism sheet PS) having a light diffusion property or a light condensing property is arranged.

### SUMMARY OF THE INVENTION

As shown in FIG. 2 which is a plan view of a liquid crystal display device, light emitting diodes LED are arranged on a side portion of a light guide plate LG in a spaced-apart manner from each other. Accordingly, in an area of a display region (DA) in the vicinity of a light source side where the light emitting diodes LED are arranged, a phenomenon that an area “a” indicated by a dotted line becomes brighter than an area surrounding the area “a”, that is, so-called brightness irregularities are liable to occur.

The liquid crystal display device which uses the light emitting diodes LED as a light source is configured such that, light which is emitted from the light emitting diodes LED and advances in the inside of the light guide plate LG (indicated by a dotted arrow in FIG. 2) spreads uniformly before arriving at an effective light emitting region (display region DA) of a screen, and the diffusion of light is generated at a light spreading end by an optical sheet having a diffusion function (diffusion sheet DS or the like) so as to eliminate the brightness irregularities. Further, there have been proposed various countermeasures to eliminate the brightness irregularities such as a change in shapes and arrangement of an uneven pattern formed on a surface of the light guide plate LG in the inside of a backlight, a change in shape and arrangement of an adhesive member and/or a non-adhesive member, a change in a shape and a surface state of an area of a sheet member having a reflection function which is arranged on a rear side of the light guide plate in the vicinity of a light source side.

However, along with the miniaturization of the liquid crystal display device, the distance between the display region DA and the light emitting diodes LED becomes shorter so that a distance that the radiation light emitted from the light emitting diodes LED advances in the inside of the light guide plate LG becomes short. Accordingly, light emitted from a point light source formed of a light emitting diode does not sufficiently uniformly spread so that the brightness irregularities of circular strong light are liable to occur. Further, even when working which sharply spreads light emitted from the light emitting diode LED is applied to the light guide plate LG by applying an uneven pattern to a light incident surface of the light guide plate LG (a side surface of the light guide plate LG in the vicinity of the light emitting diode), the local light concentration occurs leading to the occurrence of brightness irregularities of linear strong light. Further, from a viewpoint of a demand for the miniaturization and the reduction of cost of the liquid crystal display device, the decrease of the number of arranged light emitting diodes is requested so that the brightness irregularities are more liable to occur.

The invention has been made to overcome the above-mentioned drawbacks, and it is an object of the invention to provide a liquid crystal display device which can effectively suppress the occurrence of brightness irregularities without using additional members or complicated formed parts in miniaturizing the liquid crystal display device.

To overcome the above-mentioned drawbacks, the liquid crystal display device of the invention has following technical features.

(1) The invention is directed to a liquid crystal display device including: a liquid crystal display panel; and a backlight which illuminates the liquid crystal display panel, wherein the backlight includes a light guide plate, a plurality of light emitting diodes which are arranged on a side portion of the light guide plate, and an optical sheet member which is arranged between the light guide plate and the liquid crystal display panel and has a light diffusion property or a light condensing property, and a cutaway portion is formed on a side of the optical sheet member in the vicinity of the light emitting diodes.

(2) In the liquid crystal display device having the constitution (1), the optical sheet member is constituted of a plurality of stacked sheets, and the sheets are constituted of a sheet having a cutaway portion on a side thereof in the vicinity of the light emitting diodes and a sheet having no cutaway portion on a side thereof in the vicinity of the light emitting diodes.

(3) In the liquid crystal display device having the constitution (1), the optical sheet member is constituted of a plurality of stacked sheets, and a cutaway portion is formed on a side of all sheets in the vicinity of the light emitting diodes.

(4) In the liquid crystal display device having the constitution (3), the cutaway portions formed on the respective sheets differ from each other in size or position for every sheet.

According to the invention, with the simple constitution in which the cutaway portion is formed on a side of the optical sheet member in the vicinity of the light emitting diodes, it is possible to effectively suppress brightness irregularities which occur in a display region of the liquid crystal display device.

### BRIEF DESCRIPTION OF THE DRAWINGS

FIG. 1 is a cross-sectional view for explaining the structure of a liquid crystal display device;

FIG. 2 is a plan view for explaining brightness irregularities which occur in a display region of the liquid crystal display device;

FIG. 3 is a view showing a liquid crystal display device according to an embodiment of the invention; and

FIG. 4 is a view showing a liquid crystal display device according to another embodiment of the invention.

### DETAILED DESCRIPTION OF THE INVENTION

A liquid crystal display device according to the invention is explained in detail hereinafter.

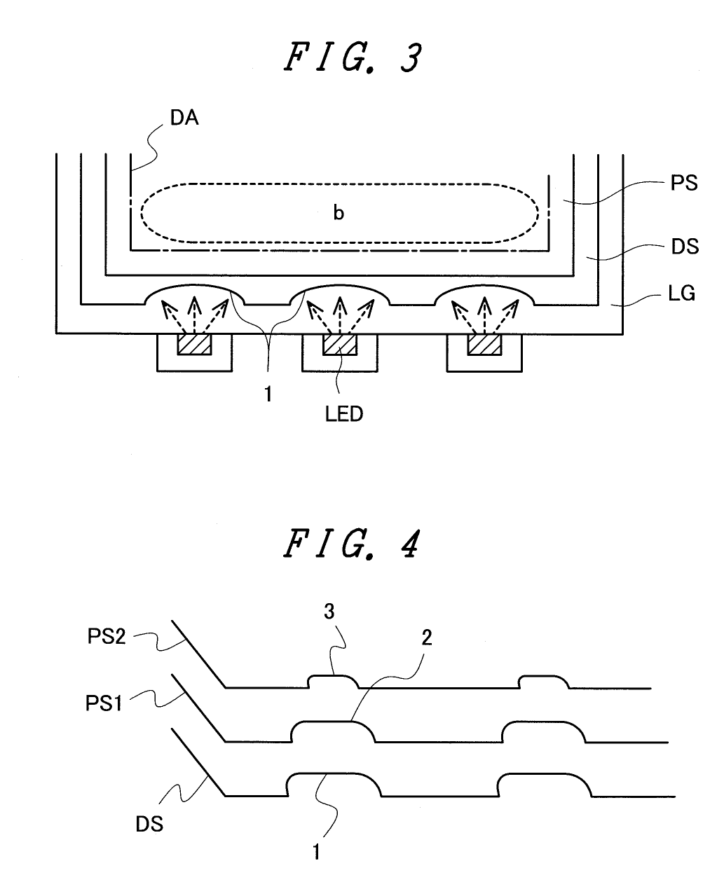

The liquid crystal display device of the invention relates to a liquid crystal display device which includes a liquid crystal display panel and a backlight which illuminates light to the liquid crystal display panel. As shown in FIG. 3, the backlight includes a light guide plate LG, a plurality of light emitting diodes LED which are arranged on a side portion of the light guide plate, and an optical sheet member (a diffusion sheet DS, a prism sheet PS) which is arranged between the light guide plate LG and the liquid crystal display panel and has a light diffusion property or a light condensing property. On a side of the optical sheet member in the vicinity of the light emitting diodes, cutaway portions 1 are formed.

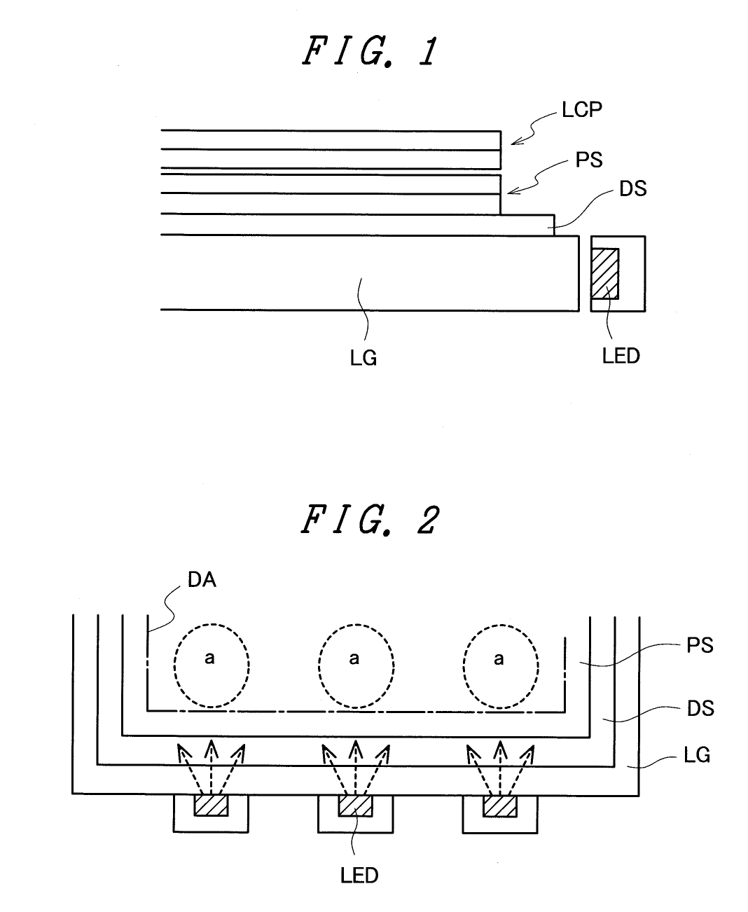

The liquid crystal display device according to the invention is, in the same manner as the liquid crystal display device shown in FIG. 1, constituted of a liquid crystal display panel LCP and a backlight which illuminates the liquid crystal display panel. The liquid crystal display panel LCP is configured such that a liquid crystal layer is arranged between two transparent substrates such as glass substrates, and color filters and pixel electrodes which respectively correspond to display pixels, lines, and thin film transistors which constitute drive elements are formed on the transparent substrates.

The backlight includes the light guide plate LG, and the light emitting diodes LED which constitute a light source are arranged on a side portion of the light guide plate LG in a spaced-apart manner from each other. Further, on a side of the light guide plate LG which faces a liquid crystal display panel LCP, an optical sheet member which is provided for ensuring the uniform illumination of the liquid crystal display panel is arranged. The optical sheet member is constituted of the diffusion sheet DS for diffusing light and the prism sheet PS for condensing or deflecting light in the specified direction. By stacking these sheets in plural number when necessary, it is possible to obtain a more uniform illumination light. On a surface of the light guide plate LG on a side opposite to a side where the optical sheet member is arranged, a reflection sheet which reflects light toward the optical sheet member side is arranged. Further, an uneven shape for reflection is formed on a surface of the light guide plate LG.

In the liquid crystal display device of the invention, for suppressing circular or linear brightness irregularities which occur in the above-mentioned display region, as shown in FIG. 3, on the optical sheet member having a light diffusion property or a light condensing property, the cutaway portions 1 are formed on a side of the optical sheet member in the vicinity of the light emitting diodes LED. Particularly, by forming the elliptical cutaway portion 1 on portions of the optical sheet member which faces the light emitting diodes LED in an opposed manner, it is possible to control light which is emitted from the light emitting diodes LED and advances in the inside of the light guide plate LG such that the light spreads uniformly. Further, the spread light is diffused by the optical sheet member and, more particularly, by the diffusion sheet DS of the optical sheet member thus eliminating brightness irregularities which occur on a screen in the vicinity of a light source side in the display region DA. As a result, it is possible to realize the illumination where the brightness irregularities are suppressed in a region b indicated by a dotted line in FIG. 3.

A shape of the cutaway portions 1 which are formed on the optical sheet member is not limited to an elliptical shape. That is, the cutaway portions 1 may have a rectangular shape or a triangular shape for controlling the degree of spreading light emitted from the light emitting diodes LED by taking a size of the liquid crystal display device or the required brightness distribution into consideration.

The optical sheet member is constituted by stacking optical sheets such as a diffusion sheet and a prism sheet. The stacked optical sheets may be constituted of an optical sheet which includes cutaway portions on a side thereof in the vicinity of the light emitting diodes and another optical sheet which does not include cutaway portions on a side thereof in the vicinity of the light emitting diodes. By adopting such a constitution, the number of optical sheets on which the cutaway portions are formed can be minimized so that a design change from conventional manufacturing parts can be minimized thus suppressing the increase of a manufacturing cost.

Either one of the diffusion sheet DS and the prism sheet PS may be used as the optical sheet on which the cutaway portions are formed. It is preferable, however, that the cutaway portions are formed on the optical sheet which is arranged closest to the light guide plate LG and the light emitting diodes LED. Further, with respect to the diffusion sheet and the prism sheet, it is preferable to form the cutaway portions on the diffusion sheet from a viewpoint of spreading light uniformly.

Further, the cutaway portions may be formed on all of plurality of optical sheets which constitute the optical sheet member on a side of the optical sheets in the vicinity of the light emitting diodes. By forming the cutaway portions on the large number of optical sheets, it is possible to diffuse light emitted from the light emitting diodes in the more diverse directions thus further suppressing the brightness irregularities in the display region.

Further, in forming the cutaway portions on the plurality of optical sheets, it is preferable that, as shown in FIG. 4, the cutaway portions 1 to 3 formed on the respective sheets (diffusion sheet DS, prism sheets PS1, PS2) differ from each other in size or position for every sheet. Due to such a constitution, the diffusion direction of light is diversified. Further, in arranging the plurality of optical sheets in an overlapping manner, by forming the cutaway portions such that positions of the cutaway portions are displaced from each other, in the same manner as the constitution in patent document 1, it is possible to prevent an error in stacking the optical sheets in order or forgetting of stacking an optical sheet during a step of assembling the backlight.

As has been explained heretofore, according to the invention, it is possible to provide the liquid crystal display device which can effectively suppress the occurrence of brightness irregularities without using additional members or complicated formed parts in miniaturizing the liquid crystal display device.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a liquid crystal display panel; and
a backlight which illuminates the liquid crystal display panel, wherein
the backlight includes a light guide plate, a plurality of light emitting diodes which are arranged on a side portion of the light guide plate, and an optical sheet member which is arranged between the light guide plate and the liquid crystal display panel and has a light diffusion property or a light condensing property, and
a cutaway portion is formed on a side of the optical sheet member in the vicinity of the light emitting diodes.

2. The liquid crystal display device according to claim 1, wherein the optical sheet member is constituted of a plurality of stacked sheets, and the sheets are constituted of a sheet having a cutaway portion on a side thereof in the vicinity of the light emitting diodes and a sheet having no cutaway portion on a side thereof in the vicinity of the light emitting diodes.

3. The liquid crystal display device according to claim 1, wherein the optical sheet member is constituted of a plurality of stacked sheets, and a cutaway portion is formed on a side of all sheets in the vicinity of the light emitting diodes.

4. The liquid crystal display device according to claim 1, wherein the cutaway portions formed on the respective sheets differ from each other in size or position for every sheet.

5. A liquid crystal display device comprising:
a liquid crystal display panel; and
a backlight which illuminates the liquid crystal display panel, wherein
the backlight includes a light guide plate, a plurality of light emitting diodes which are arranged on a side portion of the light guide plate, and an optical sheet member which is arranged between the light guide plate and the liquid crystal display panel and has a light diffusion property or a light condensing property, and
a cutaway portion is formed on a side of the optical sheet member in the vicinity of the light emitting diodes and outside a display region.

6. The liquid crystal display device according to claim 5, wherein the optical sheet member is constituted of a plurality of stacked sheets, and the sheets are constituted of a sheet having a cutaway portion on a side thereof in the vicinity of the light emitting diodes and a sheet having no cutaway portion on a side thereof in the vicinity of the light emitting diodes.

7. The liquid crystal display device according to claim 5, wherein the optical sheet member is constituted of a plurality of stacked sheets, and a cutaway portion is formed on a side of all sheets in the vicinity of the light emitting diodes.

8. The liquid crystal display device according to claim 5, wherein the cutaway portions formed on the respective sheets differ from each other in size or position for every sheet.

9. A liquid crystal display device comprising:
a liquid crystal display panel; and
a backlight which illuminates the liquid crystal display panel, wherein
the backlight includes a light guide plate, a plurality of light emitting diodes which are arranged on a side portion of the light guide plate, and an optical sheet member which is arranged between the light guide plate and the liquid crystal display panel and has a light diffusion property or a light condensing property, and
a cutaway portion is formed on a side of the optical sheet member in the vicinity of the light emitting diodes and outside a display region where the optical sheet does not overlap with the liquid crystal display panel.

10. The liquid crystal display device according to claim 9, wherein the optical sheet member is constituted of a plurality of stacked sheets, and the sheets are constituted of a sheet having a cutaway portion on a side thereof in the vicinity of the light emitting diodes and a sheet having no cutaway portion on a side thereof in the vicinity of the light emitting diodes.

11. The liquid crystal display device according to claim 9, wherein the optical sheet member is constituted of a plurality of stacked sheets, and a cutaway portion is formed on a side of all sheets in the vicinity of the light emitting diodes.

12. The liquid crystal display device according to claim 9, wherein the cutaway portions formed on the respective sheets differ from each other in size or position for every sheet.
